(19) United States
(12) Patent Application Publication
(10) Pub. No.: US 2016/0063531 A1
(43) Pub. Date: Mar. 3, 2016

(54) Providing prepaid subscribers with pre-disclosed discounted rates for a variety of service providers

(71) Applicant: Nour Rahhal, Lake Forest, CA (US)

(72) Inventor: Nour Rahhal, Lake Forest, CA (US)

(21) Appl. No.: 14/448,627

(22) Filed: Sep. 2, 2014

(51) Int. Cl. G06Q 30/02; G06Q 20/28

(52) U.S. Cl. CPC G06Q 30/0213; G06Q 20/28

(57) ABSTRACT

A system and method for providing a prepaid subscription to discounted rates on select contracted service providers. The method comprises subscribing of the new website visitor to a prepaid contracted service membership; accessing to various contracted service providers and their contact information near current location; accessing to reviews and current customer ratings of contracted service providers; contacting and visiting contracted service providers; confirming validity of subscriber membership and receiving of discounted rates on applicable services.

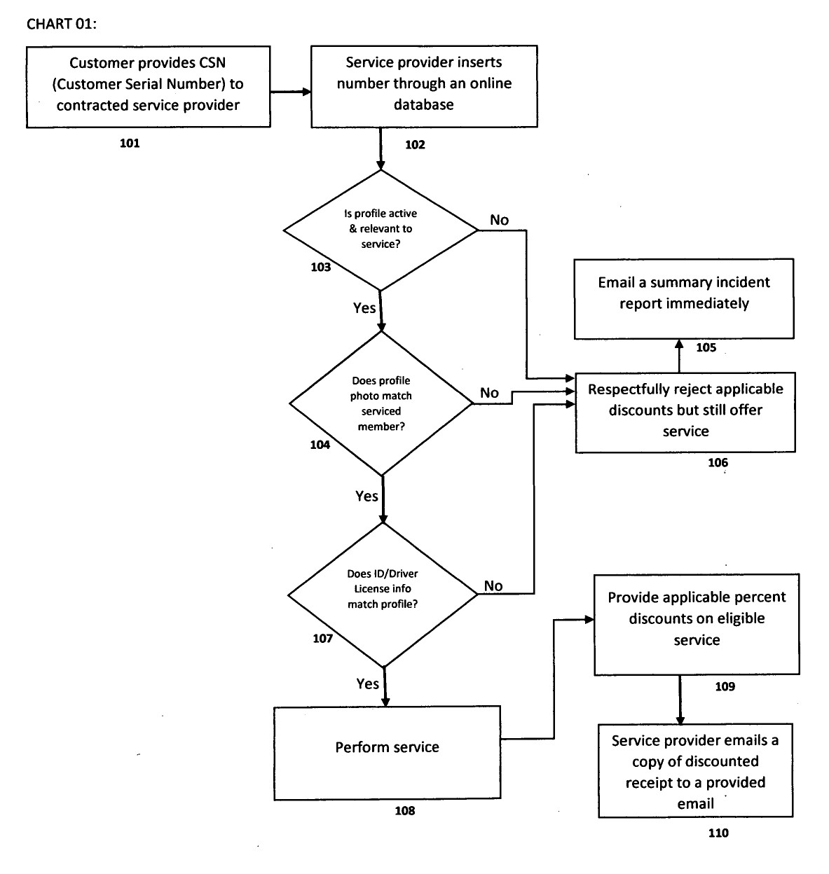

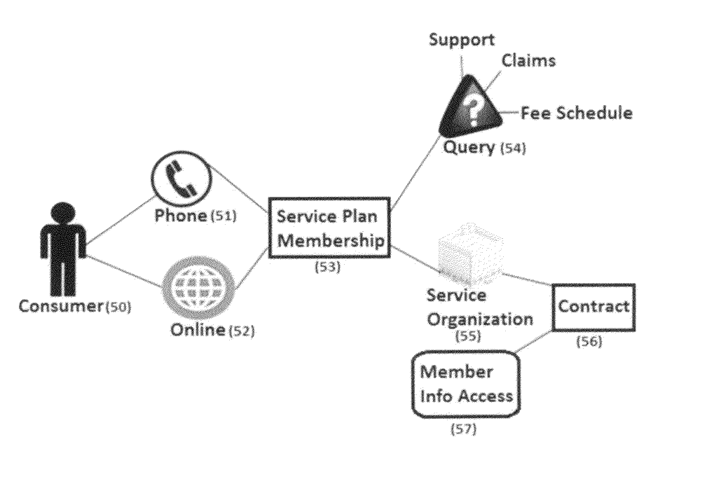

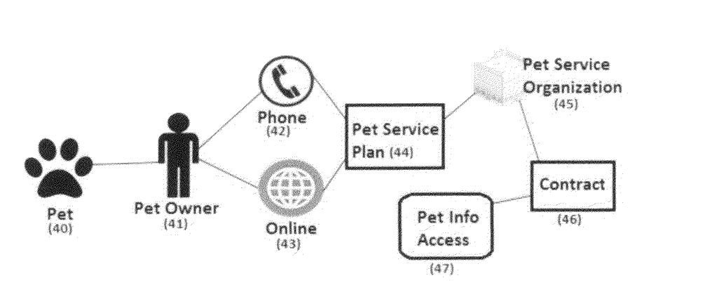

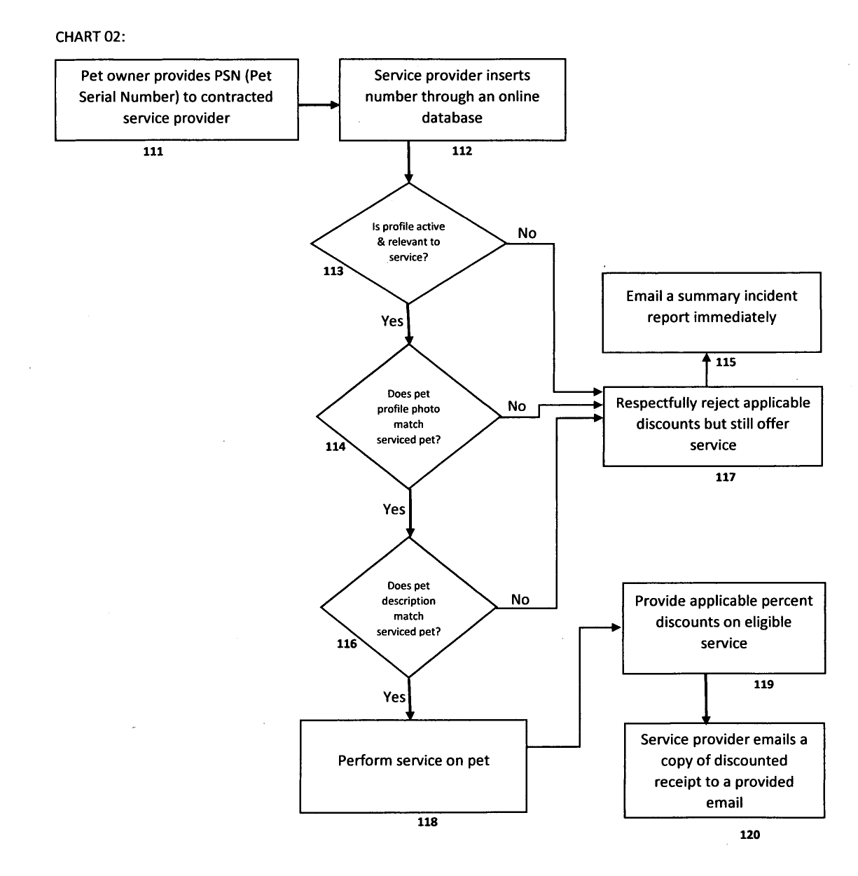

### CROSS REFERENCE TO RELATED APPLICATIONS

This application claims priority benefits under 35 U.S.C. 120 to U.S. Nonprovisional patent application Ser. No. 14/448,627, filed on Jul. 31, 2014.

### BACKGROUND OF THE INVENTION

Imagine a world where people can be part of a community that offers benefits on the services they utilize on regular basis. Taking advantage of the ease of online technology to provide access to discounted rates on main and often used services establishes one of the main goals of the invention. Other goals include providing discounted rates through a simple step by step process, without excessive conditions and restrictions, such as pre-existing conditions for pet health related services. The invention grabs the idea of insurance and turns it into a modest and easy way for the consumer to receive discounts on their commonly used services.

### BRIEF SUMMARY OF THE INVENTION

Each membership provides access to unlimited pre-disclosed service provider discounts to contracted consumers. Discounts are applied by the service provider after verifying authentication of consumer membership. Membership fees are to be prepaid monthly or yearly depending on the consumer's contract. Consumer membership offers discounts to a selected type of service. Membership fees are specified to consumer prior to contract signature. Each service provider will state a range of contracted discounts of which will be visible to subscribed members prior to utilizing any services.

Consumers may obtain memberships through online interface or by phone. Once payment is confirmed, members will have access to relevant contracted service providers.

In terms of pet owners acquiring pet services for their pets, pet owners are to obtain a membership for their pet at a monthly of yearly contracted fee for which they will be provided with discounted rates for their pet services from contracted pet service providers. Similar to consumer based memberships, pet membership fees are specified and due prior to membership contract establishment. Each contracted pet service provider will disclose a range of discounts to be presented in a clear manner to the subscribed pet owner prior to servicing the pet.

### BRIEF DESCRIPTION OF CHARTS AND DRAWINGS

CHART 1 is a flow chart of an interaction between a subscribed customer and a contracted service provider.

DRAWING 1 is an explanatory drawing of the subscriber's signing up process to one of the disclosed services.

CHART 2 is a flow chart of an interaction between a subscribed pet owner and a contracted pet service provider to perform a contracted service on the pet owner's pet.

DRAWING 2 is an explanatory drawing of the subscribing process of a pet owner's pet to a pet related service.

### DETAILED DESCRIPTION OF THE INVENTION

The provided systems are to offer consumers with access to different types of discounted services provided by lawyers, pet groomers, pet medical services, dentists, hair salons, nail salons, airlines, and gas stations. Discounted fees of service providers are displayed on an online interface to consumers on the company's main website. Members are to purchase a desired plan to provide an indicated discount on contracted providers' services. Discounts are offered on eligible services to the member every time they acquire the contracted service providers.

### CHART 01:

Customer walks into a service organization and provide their assigned Customer Serial Number, CSN, to the service provider's front desk or main personal (101). Service provider is then to confirm customer's membership by entering their CSN into a predesigned secure database system, using an assigned service provider login and password (102). Once customer profile is pulled up, service provider is to verify activeness of membership account and it's relativity to the service provided. For instant, if consumer is subscribed to a dental membership, discounts may only be approved to contracted service providers in the dental services field. Utilizing discounts on law services is not related and thus discount is not honored (103). Once active and related account is verified, service provider is to validate the authentication of the member. This is done by visibly verifying the face photo on the member's account in relevance to the face of the serviced member (104). Afterward, service provider is to request a member's photo ID for final verification. Final verification is achieved by validating member's information on the ID with the online profile (107). If any information is invalid at any point of the verification, service provider may respectfully reject applicable discounts and send an email to a pre-assigned email address with a summary of the incident, including member contact information (105). Once member verification is a pass, contracted discount rates will be valid and applicable (109) and service may be performed by contracted service provider (108). Finally, a copy of receipt of services and amount of discounts applied will be scanned and emailed to a pre-assigned email address (110).

### DRAWING 01:

Once a consumer decides to sign up for a membership, they may access an online interface (52) or call by phone (51). Once information is collected and applied to newly established membership, a subscribed member is connected to a contracted service plan and membership is established (53). Once membership is established, subscriber will have instant access to discounted rates for contracted service providers listed within the membership terms. A member may visit service provider through walk-ins or appointments, depending on the service provider's terms of service (55). With the contracted membership, customer query or claims, if applicable, may be resolved by issuing online tickets or calling customer service phone numbers. Meanwhile, membership fees will be charged either directly on monthly basis or a one-time annual payment (54).

Contracted service providers will be required to associate with a contract requiring presentation of discounted rates to subscribed members (56). Service providers will also be provided with access to relevant member information (57) which will be utilized to verify members' active subscriptions.

### DRAWING 02:

A pet owner (41) may decide to subscribe his/her pet (40) for a pet service plan to take advantages of the discounted rates on pet related services by contracted pet service providers. The subscription process may be accomplished using an online interface (43) or by phone (42). Once a pet service plan (44) is assigned to a pet and personal pet information is collected and a profile is established, the pet owner may utilize the discounted rates by going to a contracted pet service organization (45). Each contracted (46) pet service provider will be provided with access to the contracted pet profile (47) to further verify and provide discounted rates to the pet owner's final bill of service.

### CHART 02:

Pet owner walks into a contracted pet service organization along with their subscribed pet and provides the applicable Pet Serial Number, PSN, to the service provider's front desk or main personal (111). Service provider is then to confirm pet's membership by entering their PSN into a predesigned secure database system, using an assigned service provider login and password (112). Once pet profile is pulled up, service provider is to verify activeness of membership account and it's relativity to the service provided. For instant, if pet is subscribed to a grooming membership, discounts may only be approved to contracted service providers in the grooming and bathing service field only. Utilizing discounts on pet health services is not related and thus discount is not honored (117). Once active and related account is verified, service provider is to validate the authentication of the pet member. This is done by visibly verifying the breed and photo on the pet member's account in relevance to the breed and look of the serviced pet (114). Afterward, service provider is to verify the general and specific description of the pet member including fur colors, age, and colors of eyes (116). If any information is invalid at any point of the verification, service provider may respectfully reject applicable discounts and send an email to a pre-assigned email address with a summary of the incident, including pet owner contact information (115). If pet member verification is completely a pass, contracted discount rates will be valid and applicable (119) and service may be performed by contracted service provider. Finally, a copy of receipt of services and amount of discounts applied will be scanned and emailed by the contracted pet service provider to a pre-assigned email address (120).

What is claimed is:

1. A computer-based system for providing prepaid subscribers with access to discounted rates on common private services, the system comprising: subscribing to preferred memberships offering relevant services by service providers including law services, pet grooming, pet medical and health services, dentistry, hair salons, nail salons, airlines, and gas stations through an access of an online interface; accessing membership details and service providers' contact information;
accessing general and relevant member support; accessing ratings of each service providers;
receiving pre-disclosed discounted rates and services from contracted service providers.

2. The method of claim 1 further comprising forwarding a copy of member's discounts received and total bill provided by service provider.

3. The method of claim 1 further comprising prepaying of membership fees on monthly or annual basis.

4. The method of claim 1 further comprising contracting of service providers.

5. The method of claim 4 wherein the service provider contracting step is accomplished by achieving an agreement with a service provider through a pre-disclosed contract.

6. The method of claim 4 wherein the service provider agreement comprising providing subscribers with contracted discounted rates in return to being provided the possibility of increase in number of new and continuing customer visits; and being provided with possible perks and bonuses given a maintained high contracted customer review on annual basis. There are no applicable fees to contracted service providers, however, they are required to honor contracted discounted rates to subscribers' services
